(19) United States
(12) Patent Application Publication
(10) Pub. No.: US 2020/0238743 A1
(43) Pub. Date: Jul. 30, 2020

(54) A METHOD AND SYSTEM FOR THE PAGINATION OF A PRINTED PUBLICATION, AND PRINTED PUBLICATION OBTAINED THEREOF

(71) Applicant: Marco António Castelão Soares, Louriçal (PT)

(72) Inventor: Marco António Castelão Soares, Louriçal (PT)

(73) Assignee: Marco António Castelão Soares, Louriçal (PT)

(21) Appl. No.: 16/756,249

(22) PCT Filed: Oct. 18, 2018
(86) PCT No.: PCT/IB2018/058076

§ 371 Date: Apr. 15, 2020

(30) Foreign Application Priority Data
Oct. 18, 2017 (PT) 11035817A

(51) Int. Cl. B42D 1/00

(52) U.S. Cl. CPC B42D 1/007; B42D 7/00; B42D 1/009

(57) ABSTRACT

The present invention is enclosed in the area of pagination of printed publications such as a newspaper or a book. It is an object of the present invention a method for the pagination of a printed publication which comprises the following steps: a) providing a sequence of media to be printed on the publication, b) providing a first positioning for even pages and a second positioning for odd pages wherein said first positioning and second positioning are such that any η odd page is: i) positioned adjacently to an η+1 first even page, and ii) has on its directly opposite side a second even page η+3, and c) printing and sequencing and d) organising the sheets, and thereby obtaining said printed publication. Such method therefore provides that two consecutive pages are always simultaneously present in a single field of view obtained from a position in front of the publication.

### FIELD OF THE INVENTION

The present invention is in the area of pagination of printed publications such as a newspaper or a book.

### PRIOR ART

Solutions exist in the art where, such as the case of patent application US 2007/0042336, a given pagination is provided in a publication such as a book. The sequential numbering and arrangement of pages in a publication has been maintained throughout the ages, such arrangement/positioning providing that each odd page has on its back side an even page. Such positioning of pages known in the art is common to Western (sequential pages are positioned from left to right) and Japanese or similar (sequential pages are positioned from right to left) standards.

However, all the existing solutions have the issue that, in a given moment, two sequentially arranged pages (for instance n and n+1) are not viewable simultaneously, since page n+1 is arranged on the back side of the sheet that contains page n on its front side. In particular, in order to overcome such an issue the page is flipped to continue reading the text at the end of page n to the text at the beginning of page n+1. It is also the case of patent EP 1942010. Such an issue leads to lack of continuity and efficiency while following the sequence of the printed publication, be it by a human or computational device.

Several more uncommon arrangements have been proposed, still failing to overcome such issues, as is the case of patent application EP 0602605.

The present solution innovatively overcomes such issues.

### SUMMARY OF THE INVENTION

It is therefore an object of the present invention a method for the pagination of a printed publication, for example a newspaper or a book, performed by an automatized printing system, which comprises the following steps:
a) providing a sequence of media to be printed on the publication, such media being continuously distributed, in said sequence, over a set of pages which are sequentially numbered from 1 to m and which form a set of sheets, m being an integer positive number,
b) providing a first positioning for even pages of such printed publication and a second positioning for odd pages of such printed publication wherein said first positioning and second positioning are such that any n odd page is: i) when the publication is in an open position, positioned adjacently to an n+1 first even page, and ii) has on its directly opposite side a second even page n+3, in which n is an integer positive number and n≤m,
c) printing and sequencing a set of pages 1 to m through said first and second positioning, and
d) organising the sheets in the same sequence as of step c), and thereby obtaining said printed publication.

Such method therefore provides that two consecutive pages are always simultaneously present in a single field of view obtained from a position in front of the publication. Unlike prior art, such effect is obtained in every situation: both when i) the publication is in an open position, in such case pages n+1 and n being viewable from said position, and ii) when a given page is flipped, since when such page is in a turning position (when it is substantially perpendicular to the remaining pages of the publication), pages n+1 and n+2 are viewable. Such effect is clearly seen in the FIGS. 1a, 1b, 2a and 2b. As referred, n and m are integer positive numbers, thus belonging to Z. Number n represents the numbering/position of any given page and m the total number of pages of the publication. Therefore, n≤m. As is clear from the above description, an odd or even number being assigned to a certain page will depend on the position in the page in the whole set of pages 1 to m, after distribution of media over the pages. Within the terms of the present invention, each sheet is formed by two pages, which correspond to the two sides of the sheet. It may be that a larger sheet contains two of the sheets as above described, which is typically the case when printing a book, in which each two sheets are together in a larger sheet, such larger sheets then forming groups and being organised with each larger sheet being put inside the previous one. Such grouping is typically called a booklet. It is the case of a book with A4 larger sheets, which form A5 sheets. As is clear, the present invention is also applicable to such case. With regard to the method of the present invention, the printed publication may consist of a paper based product, such as a book, newspaper, periodical, magazine or a digital device with a screen mimicking a physically-based product. Such digital device mimics in a component, such as a screen, a physically-based product, such as a book or a newspaper. Printing may be performed by a printing driver, be it to interface with a virtual or physical printer, and/or a printer.

Such simultaneity is quite relevant for a printed publication only comprising text, since it allows a computational device comprising a camera or a human reader to easily maintain a continuous sequence at every time. Automatic page flipping means known in the art may be associated with such computational device for higher automation. However, said simultaneity is even more important where the media to be printed comprises images, namely comics, where continuity plays a more relevant role.

It is also an object of the present invention a printed publication obtained by the method of the present invention in any of its described embodiments, such printed publication preferably consisting of a book, newspaper, periodical, magazine or a digital device with a screen mimicking a physically-based product. Such digital device mimics in a component, such as a screen, a physically-based product, such as a book or a newspaper.

It is yet an object of the present invention an automatized printing system which is configured to implement the method of the present invention, in any of its described embodiments. In particular, such system comprises computational means configured to perform steps a) and b) of the method and automatic printing means configured to perform steps c) and d) of the method. The automatic printing means may contain a printing driver, be it to interface with a virtual or physical printer, and/or a printer.

### DESCRIPTION OF FIGURES

FIG. 1a—representation of an embodiment of the printed publication of the present invention, in particular in the Japanese standard, i.e. when the publication is in an upright open position, the n odd page is on the left side and the n+1 first even page positioned adjacently on the right side. In such case, media is printed with an orientation parallel to a smaller dimension of each sheet.

FIG. 1b—representation of an embodiment similar to that of FIG. 1a, for the Japanese standard. In such case, media is printed with an orientation parallel to a greater dimension of each sheet.

FIG. 2a—representation of an embodiment of the printed publication of the present invention, in particular in the Western standard, i.e. when the publication is in an upright open position, the n odd page is on the right side and the n+1 first even page positioned adjacently on the left side. In such case, media is printed with an orientation parallel to a smaller dimension of each sheet.

FIG. 2b—representation of an embodiment similar to that of FIG. 2a, for the Western standard. In such case, media is printed with an orientation parallel to a greater dimension of each sheet.

### DETAILED DESCRIPTION

The more general and advantageous configurations of the present invention are described in the Summary of the invention. Such configurations are detailed below in accordance with other advantageous and/or preferred embodiments of implementation of the present invention.

The automatized printing system which implements the method of the present invention may comprise several components which allow it to automatically or semi-automatically perform the several steps of the method. In particular, it may comprise automatic printing means, which include the automatic feeding of the base to be printed—which preferably comprises a paper-based product—and the automatic delivery of the printed publication, including the organising of sheets. Sheets can be, for instance, piled on top of each other. Providing of the sequence of media to be printed and of the first and second positioning of pages may be provided by a computational device, which performs such actions. Such a computational device is a part of said system, although it is not required to be physically in the same place as the printing means. Information on such pagination may be performed remotely by said computational device and sent to the printing means, in a format readable by the printing means. Such physical elements are known in the art, except in that, in the known art, they are not specifically configured to implement the several innovative steps of the method of the present invention.

In a preferred embodiment of the method of the present invention, all of said sheets substantially have the same geometrical form.

In another aspect of the method of the present invention, the sheets have a rectangular form.

In two alternative aspects of the method of the present invention, the media is printed with an orientation parallel to a greater or smaller dimension of each sheet.

In two other alternative aspects of the method of the present invention, the media after step d), the sheets are bound together, where the binding may be performed over a side i) of smaller or ii) of greater dimension of said sheets.

In another aspect of the method of the present invention, after binding, a cover is connected to the sheets, optionally by gluing an inner side of a spine of the cover over a side of said sheets.

Preferably, a base to be printed of the printed publication comprises, preferably consists of, a paper-based product.

In two alternative aspects of the method of the present invention, the publication is printed according to:
the Japanese standard, thereby, when the publication is in an upright open position, the n odd page is on the left side and the n+1 first even page positioned adjacently on the right side.
the Western standard, thereby, when the publication is in an upright open position, the n odd page is on the right side and the n+1 first even page positioned adjacently is on the left side.

Preferably, said media consists of text, one or more images or combinations thereof, wherein graphs or tables are included within examples of text or one or more images.

Moreover, within the terms of the present invention, a sheet containing page 2 has on the directly opposite side of such page an unnumbered page, namely indicating the name of the author and the title of the printed publication. Such is a result of the sequencing methodology of the present invention.

In a particular aspect of the method of the present invention, it may even be that specific means for maintaining a page in a turning position (when it is substantially perpendicular to the remaining pages of the publication) are provided, thereby enabling that a reader, for instance a technical practitioner reading a technical printed publication does not need to use the hands.

In the Summary of the invention, it was described an application in a booklet, in which a “larger sheet” contained two sheets as of the present invention.

As a matter of an example, is the case of a book with A4 larger sheets, which form A5 sheets.

For instance, a group of five larger sheets thus contains ten sheets. Such ten sheets contain pages 1 to 20. Page 19 would be a part of another booklet. Specifically, a first larger sheet contains, on one of its sides pages 2 and 17. On a side directly opposite to page 17 is positioned page 19. A second larger sheet—which is to be placed into the first larger sheet, thereby forming the booklet—contains, on one of its sides pages 2 and 17. On a side directly opposite to page 4 is positioned page 1, and on a side directly opposite to page 15 is positioned page 18. Such sequencing is performed for the remaining three larger sheets, of the set of five. The fifth larger sheet of the set of five—which will be the central larger sheet of the booklet—contains, on one of its sides pages 10 and 9. On a side directly opposite to page 10 is positioned page 7, and on a side directly opposite to page 9 is positioned page 12. As is clear, such grouping for booklets may be performed for any w given number of larger sheets. In the above example, w=5. A printed publication according to the present invention contains one or more booklets.

A particular embodiment of the method of the present invention, also related to the printed publication thereof obtained, is subsequently described.

With regard to such publication, the content of the page at which the reader is located and the content of the respective opposite side should therefore be presented simultaneously. This will be possible by adopting a perspective of pagination from left to right and simultaneously from the end to the beginning. Put another way, although the reading of each page of the document (printed or digital, written or pictorial) is done from left to right, turning the pages of the same will be done from left to right.

As an example, the reader would begin to read the book from the final pages, finding, on the left side of the last page, its numbering as corresponding to the number 1 of the document and, on its right side, page number 2.

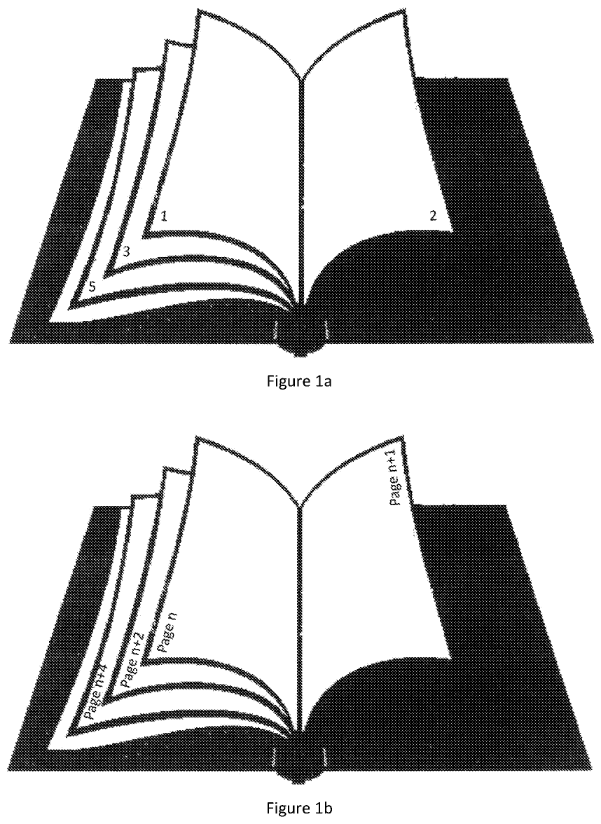

According to this new methodology, by turning page number 1 on page number 2 (in a left-to-right movement) the reader can access the content of page number 3, which will be displayed on the left side, and the content of the page number 4, visible on the right side. Thus, from the back of page number 1 will be page number 4 (FIG. 1a).

This methodology has obvious advantages. The current reading system only allows the reader to have in his/her field of view at the same time pages number 1 and 2. However, with the reading method proposed by the present invention, the reader will be able to simultaneously view (i) pages number 1 and 2 and (ii) pages 2 and 3: through the proposed model, page 1 being found on the left sheet (with page 4 on its back side) and page number 2 on the right sheet, by turning the sheet of page number 1 to the right, and maintaining such sheet vertically in transition, the reader will be able to simultaneously view pages 2 and 3. The remaining pages will follow the same logical sequence displayed in relation to pages 1 to 4 (thus, on the back of page number 3, there will be page number 6, allowing the reader, at the turn of the page, to contemplate the contents of pages number 4 and 5, on the reverse of page number 5 will be page number 8, allowing, when of a vertical, to view pages 6 and 7, etc.).

This method can also be applied in cases where the text is organized from right to left—i.e. from the end to the beginning, with regard to the Western standard—, following the Japanese standard. However, in this case, a reverse reorganisation of the one described should be adopted (i. e. the reader should start not from the final pages of the book, but from the initial ones): given that page number 1 would be on the right side and page number 2 on the left side, when turning page number 1 over page number 2 (in a movement from right to left) the reader will be confronted with the subsequent content on page number 3, shown on the right side, and page 4 on the left side. Hence, once again, on the back of page number 1 there would be page number 4 (FIG. 1a) and that, with the sheet in vertical transition, the reader will be able to simultaneously view pages number 2 and 3.

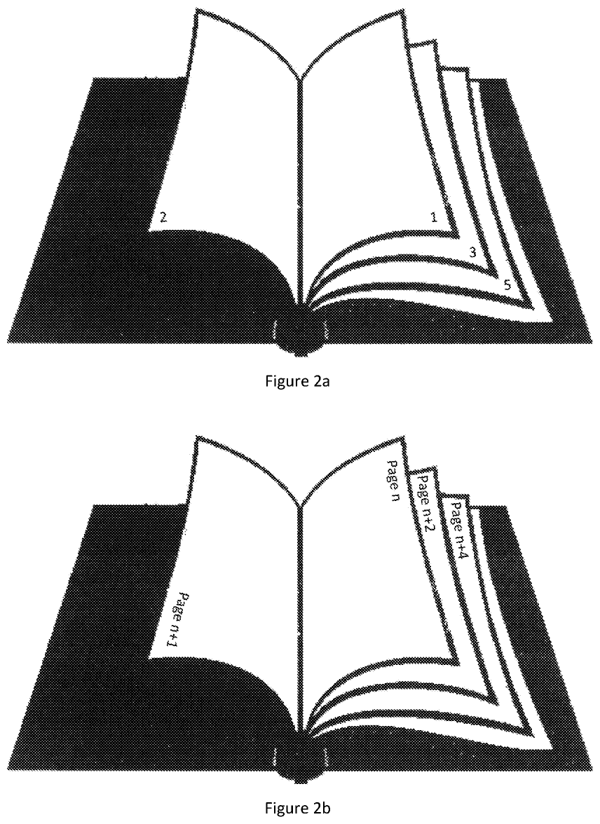

In order to facilitate the natural absorption of this new methodology, corresponding models that represent a reorganisation of the orientation of the text perpendicular to its traditional orientation are also included (FIGS. 1b and 2b). In this way, it becomes evident that the method proposed in this application can be applied regardless of the orientation of the text on the page itself (horizontal or vertical, from left to right or vice versa) and from the document reading orientation (either starting from the first few pages of the document or starting with the last).

Therefore, since the core of the method of the present invention is the possibility of simultaneous visualization of pages 1 and 2 and pages 2 and 3, it does not constitute an obstacle to the application of the proposed method, the fact that text is printed (i) with an orientation parallel to the spine (exterior or interior and separating or joining the pages/sheets) and (ii) with an orientation perpendicular to the spine (exterior or interior).

As will be clear to one skilled in the art, the present invention should not be limited to the embodiments described herein, and a number of changes are possible which remain within the scope of the present invention.

Of course, the preferred embodiments shown above are combinable, in the different possible forms, being herein avoided the repetition all such combinations.

1. A method for the pagination of a printed publication, for example a newspaper or a book, performed by an automatized printing system, characterised in that it comprises the following steps:
a) providing a sequence of media to be printed on the publication, such media being continuously distributed, in said sequence, over a set of pages which are sequentially numbered from 1 to m and which form a set of sheets, m being an integer positive number,
b) providing a first positioning for even pages of such printed publication and a second positioning for odd pages of such printed publication wherein said first positioning and second positioning are such that any n odd page is: i) when the publication is in an open position, positioned adjacently to an n+1 first even page, and ii) has on its directly opposite side a second even page n+3, in which n is an integer positive number such that n≤m,
c) printing and sequencing a set of pages 1 to m through said first and second positioning, and
d) organising the sheets in the same sequence as of step c), and thereby obtaining said printed publication.

2. A method according to the previous claim wherein all of said sheets substantially have the same geometrical form.

3. A method according to the previous claim wherein the sheets have a rectangular form.

4. A method according to the previous claim wherein the media is printed with an orientation parallel to a greater dimension of each sheet.

5. A method according to claim 3 wherein the media is printed with an orientation parallel to a smaller dimension of each sheet.

6. A method according to any of the claims 4-5 wherein, after step d), the sheets are bound together.

7. A method according to the previous claim wherein the binding is performed over a side of smaller dimension of said sheets.

8. A method according to claim 6 wherein the binding is performed over a side of greater dimension of said sheets.

9. A method according to any of the claims 6-8 wherein, after binding, a cover is connected to the sheets, optionally by gluing an inner side of a spine of the cover over a side of said sheets.

10. A method according to any of the preceding claims wherein the publication is printed according to the Japanese standard, thereby, when the publication is in an upright open position, the n odd page is on the left side and the n+1 first even page positioned adjacently on the right side.

11. A method according to any of the claims 1-9 wherein the publication is printed according to the Western standard, thereby, when the publication is in an upright open position, the n odd page is on the right side and the n+1 first even page positioned adjacently is on the left side.

12. A method according to any of the preceding claims wherein said media consists of text, one or more images or combinations thereof.

13. A method according to any of the preceding claims wherein a base to be printed of the printed publication comprises, preferably consists of, a paper-based product.

14. Printed publication characterised in that it is obtained by the method of any of the preceding claims, such printed publication preferably consisting of a book, newspaper, periodical, magazine or a digital device with a screen mimicking a physically-based product.

15. An automatized printing system characterised in that it is configured to implement the method of any of the claims 1-13, in particular comprising computational means configured to perform steps a) and b) and automatic printing means configured to perform steps c) and d).
